(19) United States
(12) Patent Application Publication
(10) Pub. No.: US 2022/0304502 A1
(43) Pub. Date: Sep. 29, 2022

(54) BEVERAGE MACHINE HEATED WATER SOURCE WITH HORIZONTAL HEATING COIL

(71) Applicant: Keurig Green Mountain, Inc., Burlington, MA (US)

(72) Inventors: Blair Mikkelsen, Chelmsford, MA (US); Steven Mackey, Dedham, MA (US); John Couture, Burlington, MA (US)

(73) Assignee: Keurig Green Mountain, Inc., Burlington, MA (US)

(21) Appl. No.: 17/640,269

(22) PCT Filed: Sep. 21, 2020
(86) PCT No.: PCT/US2020/051745

§ 371 Date: Mar. 3, 2022

Related U.S. Application Data
(60) Provisional application No. 62/904,788, filed on Sep. 24, 2019.

(51) Int. Cl. A47J 31/54; A47J 31/46; F24H 15/132; F24H 1/20

(52) U.S. Cl. CPC A47J 31/54; A47J 31/468; F24H 15/132; F24H 1/202; F24H 2250/02; H05B 2203/002

(57) ABSTRACT

A beverage machine having a heater tank with a horizontally oriented heating element. The heating element may be arranged as a helical coil with a longitudinal axis arranged horizontally in the heater tank. A bottom wall of the heater tank may define a concave shape at the interior of the heater tank, and the heating element may be at least partially arranged within the concave shape, e.g., with a longitudinal axis of the coil extending along a central portion of the bottom wall. An inlet to the heater tank may be arranged at the bottom wall, e.g., in the central portion of the bottom wall, and may direct liquid at the heating element.

### CROSS REFERENCE TO RELATED APPLICATION

This application claims the benefit of U.S. Provisional Application No. 62/904,788, filed Sep. 24, 2019, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Patent Application publication 2008/0134902 discloses a beverage forming system that heats water in a reservoir and pneumatically delivers the heated water to a brew chamber for making a coffee drink or other beverage. U.S. Pat. No. 7,398,726 discloses another beverage forming system that delivers heated water from a dispensing tank to a brew chamber by pneumatic forcing of the water from the metering tank. U.S. Pat. No. 8,094,998 and U.S. Patent application publication 2017/0307252 disclose other system types in which water in a heater tank is forced to flow out of the tank and to a beverage making station or dispensing location by introducing unheated water into the tank.

### SUMMARY OF INVENTION

In accordance with an aspect of the invention, a beverage machine includes a liquid supply arranged to provide a liquid for forming a beverage, e.g., including a water reservoir, a pump to deliver water from the reservoir to other portions of the machine, a controller to control operation of the pump, etc. A dispensing station may be arranged to dispense heated liquid for a beverage using liquid received from the liquid supply, e.g., including a brew chamber arranged to receive and hold a beverage ingredient (such as ground coffee) for mixing with water or other liquid to form a beverage. The machine may include a heater tank having an inlet arranged at a bottom wall of the heater tank to receive liquid from the liquid supply, and an outlet arranged to provide heated liquid to the dispensing station. The heater tank may define a chamber to hold liquid and a heating element at least partially in the chamber arranged to heat liquid in the chamber. The heating element may have at least a portion arranged as a coil having a longitudinal axis arranged horizontally in the heater tank. For example, the heating element may be arranged as a helical coil having at least three turns that extend around the longitudinal axis.

In one embodiment, the inlet is arranged to direct liquid into the chamber in a direction directly toward an exterior side of the heating element, e.g., to help ensure that incoming water is heated by the heating element. In some cases, the inlet is arranged to direct liquid toward the coil portion of the heating element in a direction perpendicular to the longitudinal axis of the heating element coil.

In one embodiment, the bottom wall of the heater tank defines a U-shaped trough or channel in the chamber, and the heating element is at least partially positioned within the U-shaped trough, e.g., at least a portion of the coil is located in the U-shaped trough or channel. The longitudinal axis of the heating element coil may extend along a length of the U-shaped trough or channel, e.g., so as to minimize space between the coil and the walls of the heater tank. In some cases, the inlet may be arranged at a bottom of the U-shaped trough or channel. In one embodiment, the bottom wall includes a horizontal central portion and a pair of angled portions on opposed sides of the central portion, with each of the pair of angled portions arranged to diverge upwardly and away from the central portion. Thus, the pair of angled portions and the central portion of the bottom wall may define a concave shape in the chamber, and the heating element may be arranged at least partially within the concave shape, e.g., at least part of the coil may be positioned in the concave shape. In some cases, the horizontal axis of the heating element coil extends along a length of the central portion.

In one embodiment, the heating element has a pair of ends that extend through the bottom wall of the heater tank, e.g., where the heating element is an electrical resistance heating element, the ends may provide an electrical connection to the heating element.

In some embodiments, the heater tank may include a low water probe arranged in the heater tank to detect if insufficient water is in the chamber for operation of the heating element, and/or a tank empty probe arranged in the heater tank to detect if the chamber is empty of water.

The machine may include various other features, e.g., the dispensing station may include a brew chamber arranged to hold a beverage material for mixing with the liquid to form a beverage. The liquid supply may include a pump and the liquid supply may be arranged such that the pump selectively pumps liquid to inlet of the heater tank, which causes liquid to exit the heater tank via the outlet.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a left side perspective view of a beverage forming system in an illustrative embodiment;

FIG. 2 is a right side view of the beverage forming system in FIG. 1;

FIG. 3 shows a schematic diagram of functional components of the beverage forming system in an illustrative embodiment;

FIG. 4 shows an exploded view of a heater tank in an illustrative embodiment;

FIG. 5 shows a vertical cross sectional view of the FIG. 4 heater tank taken along a plane parallel to a longitudinal axis of a coil portion of the heating element;

FIG. 6 shows a cross sectional view of the lower part of the heater tank and heating element taken in a plan perpendicular to the longitudinal axis of the coil;

FIG. 7 is a perspective view of the heating element;

FIG. 8 shows a bottom perspective view of the lower part of the heater tank;

FIG. 9 shows a top view of the lower part of the heater tank and heating element; and

FIG. 10 shows a bottom view of the heater tank.

### DETAILED DESCRIPTION

It should be understood that aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

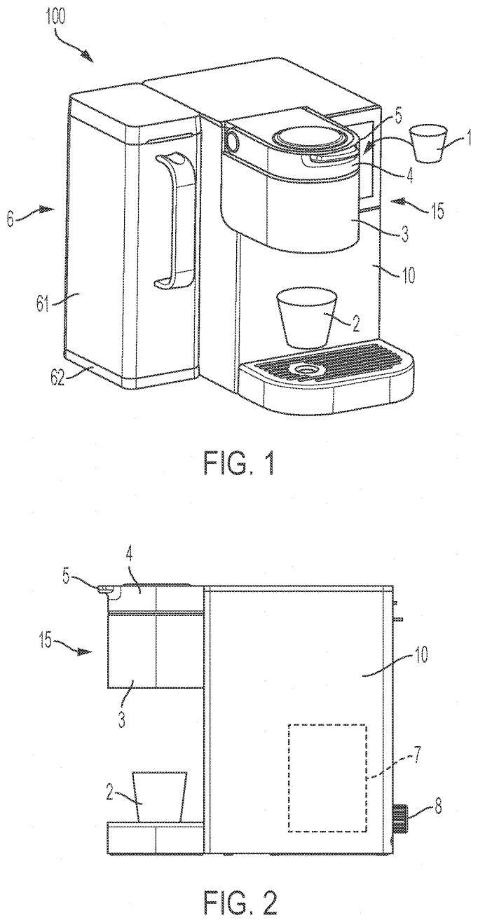

FIG. 1 shows a perspective view of a beverage forming system 100 that incorporates features of the invention. Although the beverage forming system 100 may be used to form any suitable beverage, such as tea, coffee, other infusion-type beverages, beverages formed from a liquid or powdered concentrate, soups, juices or other beverages made from dried materials, carbonated or uncarbonated beverages, or other, in this illustrative embodiment the system 100 is arranged to form coffee or tea beverages. As is known in the art, a beverage cartridge 1 may be provided to the system 100 and used to form a beverage that is deposited into a user's cup or other suitable container 2. The cartridge 1 may be manually or automatically placed in a brew chamber 15 that includes a cartridge holder 3 and cover 4 of the beverage forming system 100. For example, the holder 3 may be or include a circular, cup-shaped or otherwise suitably shaped opening in which the cartridge 1 may be placed. With a cartridge 1 placed in the cartridge holder 3, a handle 5 may be moved by hand (e.g., downwardly) so as to move the cover 4 to a closed position (as shown in FIG. 1). In the closed position, the cover 4 at least partially covers the cartridge 1, which is at least partially enclosed in a space in which the cartridge is used to make a beverage. For example, with the cartridge 1 held by the cartridge holder 3 in the closed position, water or other liquid may be provided to the cartridge 1 (e.g., by injecting the liquid into the cartridge interior) to form a beverage that exits the cartridge 1 and is provided to a cup 2 or other container. Of course, aspects of the invention may be employed with any suitably arranged system 100, including drip-type coffee brewers, carbonated beverage machines, and other systems that deliver water or other liquid to form a beverage. Thus, a cartridge 1 need not necessarily be used, but instead the brew chamber may accept loose coffee grounds or other beverage material to make a beverage. Also, the brew chamber 15 need not necessarily include a cartridge holder 3 and a cover 4. For example, the brew chamber may include a filter basket that is accessible to provide beverage material, and the filter basket itself may be movable, e.g., by sliding engagement with the beverage machine 10 housing, and a cover 4 may be fixed in place. In other embodiments, the brew chamber need not be user accessible, but instead beverage material may be automatically provided to, and removed from, the brew chamber. Moreover, the system 100 need not have a brew chamber 15, but instead other types of dispensing stations, e.g., that dispense hot and/or cold water (whether still or carbonated) at an outlet such as a dispensing nozzle without mixing with any beverage ingredient. Accordingly, a wide variety of different types and configurations for a dispensing station may be employed with aspects of the invention.

As shown in FIGS. 1 and 2, liquid from either an external reservoir 6 or an internal reservoir 7 may be provided to a brew chamber 15 or other dispensing station to dispense a beverage. For example, a user may pour or otherwise provide water to an external reservoir 6, which may then be delivered to the brew chamber 15 or other dispensing station to form a beverage. Alternately, liquid may be provided from an internal reservoir 7 as shown in FIG. 2 to the brew chamber 15. The internal reservoir 7 may be provided with liquid from a mains water connection 8 which allows the machine 100 to be connected to a plumbed water source, such as a so-called city water or mains water supply. Such a supply is typically under pressure, and thus the mains water connection 8 may be configured to receive water at relatively high pressure, such as 60 psi or more. The internal tank 7 may be fluidly coupled to the mains water connection 8 so that water can be delivered to and stored by the internal tank 7 for delivery to the brew chamber 15. In some embodiments, the internal tank 7 may optionally be provided with liquid by a user, e.g., by pouring the liquid through an opening in the beverage machine housing 10 into the internal tank 7.

By arranging the beverage machine 100 with the ability to provide water from either an external reservoir 6 or an internal reservoir 7, a user may have different options for configuring the machine 100 in different environments. In some cases, a user may wish to use liquid in the external reservoir 6 for some beverages, and use liquid in the internal reservoir 7 for other beverages. City water in the internal reservoir 7 may be used for flavored beverages, while specially filtered or otherwise treated water in the external reservoir 6 may be used for other beverages, as merely one example. A user may manually operate a valve to switch between the reservoirs 6, 7, or may interact with another user interface component, such as a button or touch screen icon, that causes a controller to adjust the valve to supply liquid from a selected reservoir 6, 7. In this embodiment, the external reservoir 6 includes a tank 61 which is removable from a tank base 62, e.g., to allow the tank 61 to be more easily filled with water. The tank base 62 may additionally be removable from the housing 10 if the external reservoir 6 is not used.

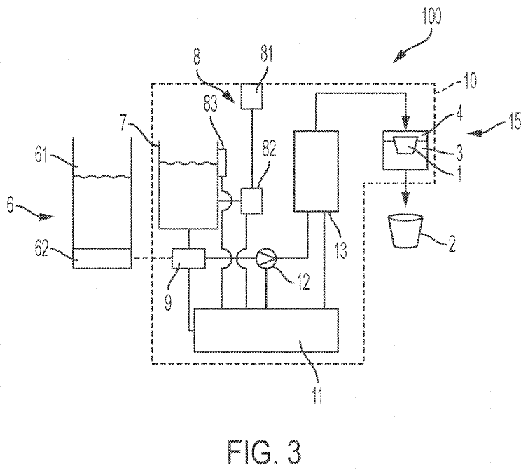

FIG. 3 shows a schematic diagram of a liquid supply and other components of a beverage machine 100 for handling liquid used to make a beverage. As noted above, the liquid supply of the machine 100 in this embodiment includes an external reservoir 6 and an internal reservoir 7. In this arrangement, the mains water connection 8 includes a connector 81 configured to fluidly connect to a hose, pipe, tube, fitting or other component that provides mains water to the connector 81, a mains valve 82 that controls flow of mains water to the internal reservoir 7 and a level sensor 83 to detect a liquid level in the internal reservoir 7. The mains valve 82 can be controlled by a controller 11 based on information from the liquid level sensor 83, e.g., the mains valve 82 can be opened to allow flow until the level in the internal reservoir 7 reaches a particular level, at which point the mains valve 82 is closed to flow. The internal reservoir 7 may be vented to hold liquid at ambient pressure, allowing the internal reservoir 7 to be made less robustly since the reservoir 7 need not be arranged to withstand the pressure of the mains water supply.

A distribution valve 9 can selectively couple either of the reservoirs 6, 7 to the brew chamber 15 or other dispensing station arrangement for delivery of liquid. The distribution valve 9 may be controllable, such as manually by a user or electronically by a controller 11, to select between the external reservoir 6 and internal reservoir 7. For example, the distribution valve 9 may have a knob, button, slider or other user actuable element on the housing 10 that can be pressed, turned or otherwise actuated to select between the reservoirs 6, 7, i.e., to select which reservoir 6, 7 will provide liquid to form a beverage. Where the valve 9 is electrically actuable, the user actuable element may include an electronic switch or other user interface component that provides information to the controller 11, which may control the valve 9 accordingly. Alternately, the controller 11 may automatically control the valve 9 based on other information, such as beverage formation parameters defined by a type of beverage to be made. Beverage parameters may be set by default by the controller 11, by a user interacting with a user interface, and/or by reading a machine readable feature on a cartridge 1 and using corresponding parameters.

In this embodiment, the liquid supply of the machine 100 includes a pump 12 which pumps liquid from the valve 9 to a heater tank 13. Employing a pump 12 may allow the machine 100 to vary a flow rate and/or pressure of the liquid as desired, e.g., to form espresso-type or other beverages using higher pressure liquid as well as drip-type coffee or other beverages made using lower pressure liquid. In this embodiment, the pumping of water or other liquid into the heater tank 13 causes heated liquid to flow to the brew chamber 15. Heated liquid is delivered to the brew chamber 15 for mixing with a beverage medium (or not) and for dispensing as a beverage.

In accordance with an aspect of the invention, the heater tank includes a heating element arranged at least in part as a coil having a longitudinal axis arranged horizontally in the heater tank. This is in contrast to arrangements in which the heating element has a coil shape, but is arranged so that a longitudinal axis of the coil is oriented vertically in the heater tank. The inventors have found that such an arrangement may provide less than ideal heating in some circumstances, e.g., allowing water entering the heater tank to bypass the heating element by flowing through the coil-shape without contacting the heating element. Arranging the heating element as including a coil shape with a longitudinal axis oriented horizontally has been found to reduce or eliminate such bypass and/or to provide more consistent heating and/or temperature of water exiting the heater tank.

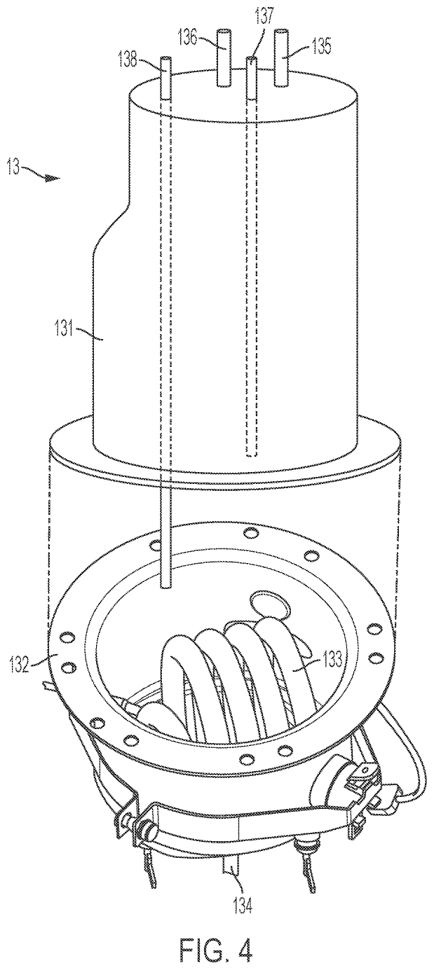

FIG. 4 shows an embodiment of a heater tank 13 that incorporates one or more aspects of the invention. In this embodiment, the heater tank 13 includes upper and lower parts 131, 132 that together define a chamber in which liquid is held for heating by a heating element 133. The lower part 132 defines an inlet 134 via which liquid is introduced into the heater tank 13, and the upper part 131 defines an outlet 135 via which heated liquid exits the heater tank 13. The upper part 131 also defines an air inlet 136 via which pressurized air may be introduced into the heater tank 13, e.g., for purging a supply line between the heater tank 13 and brew chamber 15 at the end of beverage formation cycle, and/or for purging the heater tank 13 of liquid by forcing liquid out of the inlet 134. The upper part 131 supports a low water probe 137 and an empty tank probe 138, which are used to detect whether sufficient water is present in the heater tank 13 for the heating element 133 to operate and if the heater tank 13 is empty of liquid, respectively. The low water probe 137, which has a distal end positioned above and near to the heating element 133, can be used by the controller 11 to help avoid damage to or unnecessary operation of the heating element 133 when a water level in the heater tank 13 is low. The empty tank probe 138, which has a distal end positioned at or near a bottom of the heater tank 13, can be used by the controller 11 to detect and confirm that the heater tank 13 is empty of liquid, e.g., after the heater tank 13 is purged of all liquid.

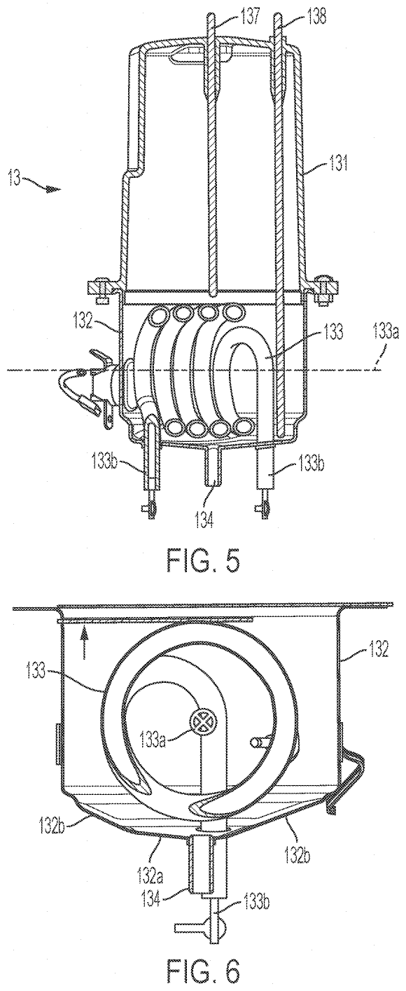

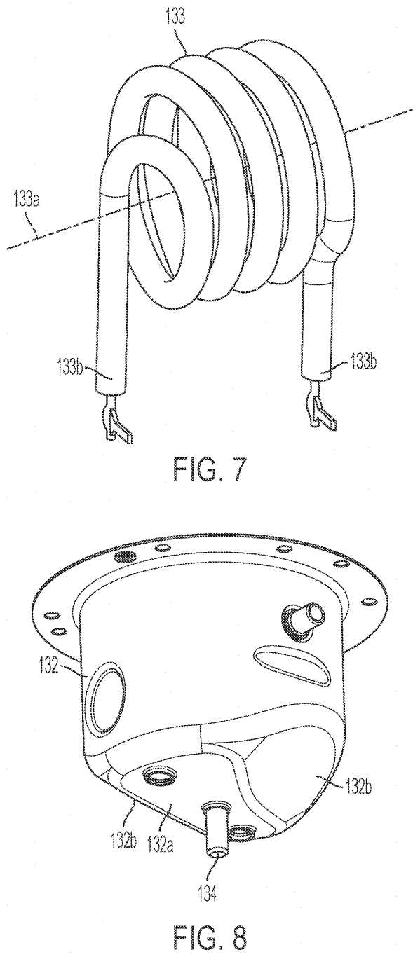

As can be seen in FIGS. 5-7, the heating element 133 has a coil shape, e.g., a helical coil arrangement having at least three turns or segments that extend 360 degrees about a longitudinal axis 133a. Also, the coil portion of the heating element 133 is arranged so that the longitudinal axis 133a of the coil is oriented in a horizontal direction. In this embodiment, the inlet 134 is arranged to direct liquid into the chamber of the heater tank 13 in a direction directly toward an exterior side of the heating element 133, in this case to an exterior side of the coil shape of the heating element 133. In addition, although not required, the inlet 134 is arranged to direct liquid toward the heating element 133 in a direction perpendicular to the longitudinal axis 133a of the coil portion of the heating element 133. This arrangement can help ensure that incoming liquid contacts at least a portion of the heating element 133 so as to be heated before passing toward the outlet 135. The heating element 133 is arranged as an electrical resistance heating element, although other arrangements are possible, such as heat exchanging tubes or other elements that transfer heat from a working fluid in the heat exchanger to the liquid in the heater tank 13. The heating element 13 has a pair of ends 133b that extend through the bottom wall of the heater tank 13. The ends 133b may provide an electrical connection for the heating element 133 or other ability to provide heat to portions of the heating element 133 in the heater tank 13.

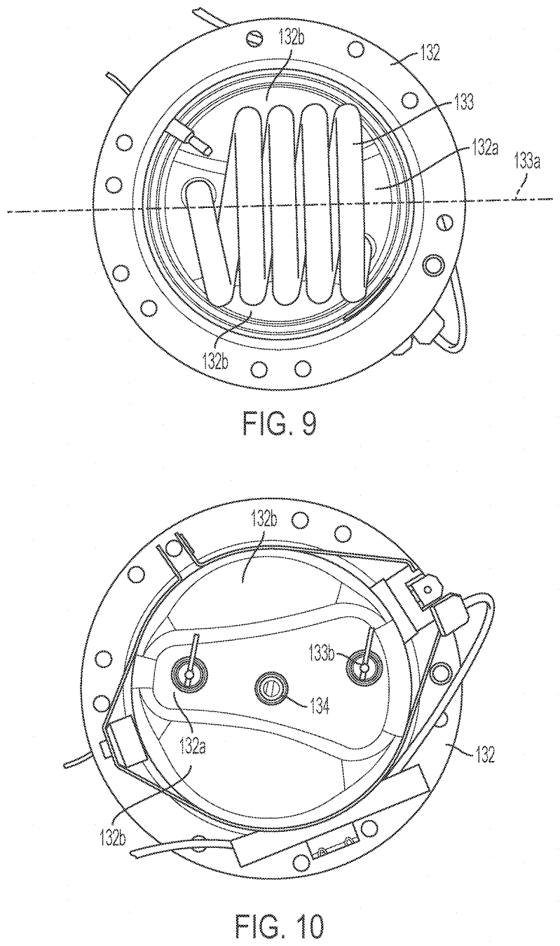

As can be seen in FIGS. 6 and 8, the bottom wall of the heater tank 13 is arranged to form a U-shaped trough, U-shaped channel or other concave-up shape in which at least a portion of the coil of the heating element 13 is received. In this embodiment, the bottom wall includes a horizontal central portion 132a and a pair of angled portions 132b on opposed sides of the central portion 132a. Each of the pair of angled portions 132b is arranged to diverge upwardly and away from the central portion 132a so as to form a concave shape at the bottom wall within which at least a portion of the coil of the heating element 133 is received. As can be seen in FIGS. 9 and 10, the horizontal axis 133a of the heating element coil extends along a length of the central portion 132a of the bottom wall and/or along a length of the U-shaped trough or channel shape of the bottom wall. Such an arrangement may help position the wall(s) of the heater tank 13 relatively closely to the heating element 13, and thus aid in avoiding bypass of water flowing from the inlet 134 (located at the central portion 132a) toward the outlet 135 of the heater tank 13.

It should be appreciated that the beverage machine 100 may include different components than those shown in FIG. 3 and/or may operate in different ways. The pump 12 may be any suitable type of pump, such as a centrifugal pump, piston pump, solenoid pump, diaphragm pump, etc. Although not shown, a check valve or other flow controller (such as an electronically-controlled valve) can be used to prevent backflow or other flow in a conduit between the pump 12 and the heater tank 13, and/or the heater tank 13 and the brew chamber 15. A pressure relief valve may be used to vent any suitable section of the liquid conduit between the reservoirs 6, 7 and the brew chamber 15, e.g., in the case of pressure over a threshold level. In some embodiments, the pump 12 may pump air through the liquid conduit, e.g., to purge the liquid conduit, heater tank 13 and/or brew chamber 15. In such a case, a valve may be provided to permit air flow to the pump 12, e.g., the distribution valve 9 may have an air inlet to selectively connect the inlet of the pump 12 to an air supply.

Operation of the pump 12 and other components of the machine 100 may be controlled by the control circuit 11, which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface on the housing 10), communication buses or other links, a display, switches, relays, triacs, or other components necessary to perform desired input/output or other functions. A user interface may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

The heater tank 13 and/or the brew chamber 15 may be provided with a desired amount of liquid by any suitable technique, such as running the pump 12 for a predetermined time, detecting a flow rate or volume of liquid passing through the pump (e.g., using a flow meter), operating the pump 12 for a desired number of cycles (such as where the pump is arranged to deliver a known volume of liquid for each cycle, such as for each revolution of a pump shaft), or using any other viable technique. Alternately, the heater tank, such as a heater tank may be determined to be completely or otherwise suitably filled when a pressure sensor (not shown) detects a rise in pressure indicating that the water has reached the top of the heater tank, when a conductive probe detects the presence of liquid in an upper portion of the tank, when an optical sensor detects a presence of liquid in the tank, and others.

Liquid may be introduced into the cartridge 1 or brew chamber 15 at any suitable pressure, e.g., 1-2 psi or higher, and the pressure may be adjustable by the control circuit 11. The brew chamber 15 may include any beverage making ingredient or material, such as ground coffee, tea, a flavored drink mix, or other beverage medium, e.g., contained in a cartridge 1 or not. Alternately, the brew chamber 15 may function simply as an outlet for heated water, e.g., where a beverage medium is contained in a user's cup 2. Once liquid delivery by the pump 12 is complete, an air pump may be operated to force air into the brew chamber 15 and/or other portions of the liquid conduit to help remove liquid.

While in this illustrative embodiment, a liquid supply system arranged to provide liquid to a beverage outlet (at the brew chamber 15) may include a pump 12, other arrangements may be used. Alternately, other mechanisms for providing liquid may be used, such as by gravity flow of liquid, flow forced by air pressure, or other motive force to move liquid from a reservoir 6, 7, such as pressure from a mains water supply, and others.

For those systems employing a cartridge 1, once a cartridge is located in the brew chamber 15 in the closed position, the beverage forming system 100 may use the cartridge 1 to form a beverage. For example, one or more inlet needles associated with the cover 4 or other part of the system 100 may pierce the cartridge 1 (e.g., a lid of the cartridge) so as to inject heated water or other liquid into the cartridge 1. The injected liquid may form the desired beverage or a beverage precursor by mixing with beverage material in the cartridge 1. The cover 4, cartridge holder 3 or other portion of the system 100 may also include one or more outlet needles or other elements to puncture or pierce the cartridge 1 at an outlet side to permit the formed beverage to exit the cartridge 1. Other inlet/outlet piercing arrangements are possible, such as multiple needles, a shower head, a non-hollow needle, a cone, a pyramid, a knife, a blade, etc. In another arrangement, a beverage machine may include a piercing element (such as a spike) that forms an opening and thereafter a second inlet element (such as a tube) may pass through the formed hole to introduce liquid into (or conduct liquid out of) the container. In other embodiments, a lid or other portion of a cartridge may be pierced, or otherwise effectively opened for flow, by introducing pressure at an exterior of the lid. For example, a water inlet may be pressed and sealed to the lid exterior and water pressure introduced at the site. The water pressure may cause the lid to be pierced or otherwise opened to allow flow into the cartridge 1. In another arrangement, the cartridge lid may include a valve, conduit or other structure that opens when exposed to a suitable pressure and/or when mated with a water inlet tube or other structure. As with the inlet piercing arrangement, the outlet piercing arrangement may be varied in any suitable way. Thus, the outlet piercing element may include one or more hollow or solid needles, knives, blades, tubes, and so on. Alternately, the cartridge 1 may include a valve, septum or other element that opens to permit beverage to exit when liquid is introduced into the cartridge, but otherwise remains closed (e.g., to protect the beverage medium from external conditions such as oxygen, moisture or others). In such a case, no piercing element for forming the outlet opening is necessarily required although may be used, e.g., to allow the valve or other element to open. Also, in this illustrative embodiment the piercing element remains in place to receive beverage as it exits the opening formed in the cartridge. However, in other embodiments, the piercing element may withdraw after forming an opening, allowing beverage to exit the opening and be received without the piercing element being extended into the cartridge 1. Other arrangements for a beverage outlet are possible however, e.g., the cartridge may have a permeable portion that allows beverage to exit cartridge 1. Also, there is no requirement that an inlet and/or an outlet pierce a cartridge to provide liquid to, or receive beverage from, a cartridge. Instead, communication with a cartridge may be performed using any suitable ports or other features.

With a beverage cartridge 1 provided in the brew chamber 15 or beverage material (if used) otherwise provided with the brew chamber 15, the control circuit 11 may operate in different ways to dispense a beverage. In some embodiments, the control circuit 11 may automatically select one or more brew parameters for automatically controlling the liquid supply and heater tank portions to dispense a beverage during a dispensing operation. For example, the control circuit 11 may select default values for parameters such as a beverage volume, beverage temperature, whether beverage frothing or whipping will be employed, a beverage dispense time or speed, a precursor liquid flow rate, a precursor liquid pressure, whether beverage chilling will be employed, whether brew chamber air or steam purge will be employed, whether beverage material pre-wet or pulse-type brewing will be employed and if so time periods between liquid delivery, and others. Such parameters may be automatically determined in different ways, such as by reading parameter values from an information element (such as an RFID tag) on a cartridge 1, receiving input from a user via a user interface such as by the user pressing a button or otherwise indicating a parameter, by employing default values stored in a memory of the control circuit 11, and/or by a combination of such techniques or others. In some cases, the control circuit 11 may begin a dispensing operation once the brew parameter values are set, or in response to additional user input such as the user pressing a brew start button. In one example, a user may press one of several beverage volume buttons to select a beverage volume, and then press a brew start button to cause the control circuit 11 to start an automated dispensing operation. Parameters used to dispense a beverage may be set by default by the control circuit 11 and/or by input from the user. For example, other brew parameters such as beverage temperature, etc. may be automatically selected by the control circuit 11 using default values unless the user provides additional input to adjust those values.

The control circuit 11 may execute an automated dispensing operation (in this example in response to depression of the start button) in different ways since dispensing processes may include different steps which may be performed in series and/or in parallel. For example, in some embodiments a heater tank may store a volume of pre-heated water such that the control circuit 11 may immediately control the pump 12 to deliver additional water to the tank, thereby causing the flow of heated water from the heater tank to the brew chamber 15 at the start of a dispensing operation. In other embodiments, water in the heater tank may first need to be heated, and thus the control circuit 11 may first cause a heating element to heat water in the heater tank, and then automatically start water delivery once heating is complete. Of course, other beverage machine 100 configurations may involve other steps at part of an automated dispensing operation. For example, if the beverage machine 100 employs an inline or flow through heater as a heater tank, the control circuit 11 may cause a heating element of the inline heater to begin heating and then simultaneously or shortly thereafter begin causing water flow through the inline heater and to the brew chamber. Where no pump is used by the beverage machine 100, water flow may be caused by gravity, steam pressure in an inline heater, or other.

With water or other liquid sufficiently heated in the heater tank, the control circuit 11 may continue with the automated process of beverage dispensing by causing the pump 12 to deliver liquid to the tank, thereby delivering heated liquid to the brew chamber 15. The control circuit 11 may sense or otherwise keep track of a volume of liquid delivered to the brew chamber 15 so that the appropriate beverage volume can be dispensed. For example, the control circuit 11 may cause the pump 12 to operate a specified number of cycles where a particular volume of liquid is delivered by the pump 12 for each pump cycle. Alternately, a flow meter may be used by the control circuit 11 to detect a volume of liquid delivered to the brew chamber 15, or other techniques.

While aspects of the invention may be used with any suitable cartridge, or no cartridge at all, some cartridges may include features that enhance the operation of a beverage forming system 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed. The cartridge 1 in this example may be used in a beverage machine to form any suitable beverage such as tea, coffee, other infusion-type beverages, beverages formed from a liquid or powdered concentrate, etc. Thus, the cartridge 1 may contain any suitable beverage material, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriaceuticals, etc.), and/or other beverage-making material (such as powdered milk or other creamers, sweeteners, thickeners, flavorings, and so on). In one illustrative embodiment, the cartridge 1 contains a beverage material that is configured for use with a machine that forms coffee and/or tea beverages, however, aspects of the invention are not limited in this respect.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A beverage machine comprising:
a liquid supply arranged to provide a liquid for forming a beverage;
a dispensing station arranged to dispense heated liquid for a beverage; and
a heater tank having an inlet arranged at a bottom wall of the heater tank to receive liquid from the liquid supply, and an outlet arranged to provide heated liquid to the dispensing station, the heater tank having a chamber to hold liquid and a heating element in the chamber arranged to heat liquid in the chamber, the heating element having a coil with a longitudinal axis arranged horizontally in the heater tank.

2. The machine of claim 1, wherein the coil of the heating element is arranged as a helical coil having at least three turns.

3. The machine of claim 1, wherein the heating element has a pair of ends that extend through the bottom wall of the heater tank.

4. The machine of claim 1, wherein the heating element is an electrical resistance heating element.

5. The machine of claim 1, wherein the inlet is arranged to direct liquid into the chamber in a direction directly toward an exterior side of the coil of the heating element.

6. The machine of claim 1, wherein the inlet is arranged to direct liquid toward the coil of the heating element in a direction perpendicular to the longitudinal axis of the heating element.

7. The machine of claim 1, wherein the bottom wall includes a horizontal central portion and a pair of angled portions on opposed sides of the central portion, each of the pair of angled portions arranged to diverge upwardly and away from the central portion.

8. The machine of claim 7, wherein the pair of angled portions and the central portion of the bottom wall define a concave shape in the chamber, and the coil of the heating element is arranged at least partially within the concave shape.

9. The machine of claim 8, wherein the horizontal axis of the coil of the heating element extends along a length of the central portion.

10. The machine of claim 1, further comprising a low water probe arranged in the heater tank to detect if insufficient water is in the chamber for operation of the heating element, or a tank empty probe arranged in the heater tank to detect if the chamber is empty of water.

11. The machine of claim 1, wherein the dispensing station includes a brew chamber arranged to hold a beverage material for mixing with the liquid to form a beverage.

12. The machine of claim 1, wherein the liquid supply includes a pump and the liquid supply is arranged such that the pump selectively pumps liquid to inlet of the heater tank.

13. The machine of claim 12, wherein the heater tank is arranged such that delivery of liquid to the inlet of the heater tank causes liquid to exit the heater tank via the outlet.

14. The machine of claim 1, wherein the bottom wall defines a U-shaped trough in the chamber, and the coil of the heating element is at least partially positioned within the U-shaped trough.

15. The machine of claim 14, wherein the longitudinal axis of the coil of the heating element extends along a length of the U-shaped trough.

16. The machine of claim 15, wherein the inlet is arranged at a bottom of the U-shaped trough.

17. The machine of claim 15, wherein the heating element has a pair of ends that extend through the bottom wall of the heater tank.
